(19) United States
(12) Patent Application Publication
(10) Pub. No.: US 2008/0252725 A1
(43) Pub. Date: Oct. 16, 2008

(54) Method and Device for Tracking a Movement of an Object or of a Person

(75) Inventors: Gerd Lanfermann, Aachen (DE); Harold Geardus Pieter Hendrikus Benten, Eindhoven (NL); Ralph Braspenning, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,943

(22) PCT Filed: Sep. 21, 2006
(86) PCT No.: PCT/IB2006/053422

§ 371 Date: Mar. 25, 2008

(30) Foreign Application Priority Data
Sep. 26, 2005 (EP) 05108859.9

(51) Int. Cl. H04N 7/18; H04N 5/235

(52) U.S. Cl. 348/143; 348/222.1; 348/E07.085; 348/E09.002

(57) ABSTRACT

The invention relates to a method, a device and a computer program product for tracking a movement of an object or of a person. Tracking the movement of a person or an object by means of electronic video frames is conventional but fails if the person of object experience a sudden significant change in its translational velocity. The suggested method comprises a first step of grabbing a sequence of digital video frames and thereby capturing the object or person. At the same time measurement values of a parameter are obtained, said measurement values being indicative for the movement of the object or person being tracked by the digital video frames. In the next step the video frames are processed by means of processing logic whereby the processing logic uses a block matching algorithm, said block matching algorithm defining a pixel block in a frame and searching for this pixel block within a search area within a next frame and whereby the location of the search area within the next frame is dynamically adapted on the basis of the measurement values. The invention provides the advantage that an electronic processing of digital video frames by means of a block matching algorithm can be carried out even in those cases in which there are large changes in the velocity of the tracked object or person.

The invention refers to the field of video processing and provides a device, a corresponding method and a computer program product for extracting motion information from a sequence of video frames. The invention can be used for tracking objects which are subjected to large differences in their velocity.

Motion information can be of great importance in a number of applications including traffic monitoring, tracking people, security and surveillance. Obtaining motion information can be helpful for improving the safety of passengers within a vehicle if the vehicle is subjected to a collision with another vehicle or with an object. In this case the temporal movement of the passengers is important for optimizing the exact time when an airbag shall be triggered, and for the proper design of the airbag during the stages of its inflation.

Digital video processing evolved tremendously over the last couple of years. Numerous publications have tackled the problem of detecting the movements of objects such as cars or persons. Even for a relatively simple task such as speed estimation of vehicles existing solutions use a combination of memory intensive algorithms and/or algorithms which need a massive computing power. Algorithms being known for that purpose make use of object recognition, object tracking, or make a comparison of images taken at different moments in time. It is therefore difficult and expensive to implement a real-time system for such applications.

True motion estimation is a video processing technique applied in high-end TV sets. These TV sets use a frame rate of 100 Hz instead of the standard 50 Hz. This makes it necessary to create new intermediate video frames by means of interpolation. For doing that with a high frame quality the motion of pixel blocks in the two-dimensional frames has to be estimated. This can be done by a 3D recursive search block matching algorithm as described in the document of Gerard de Haan et al, “True motion estimation with 3D-recursive search block matching”, IEEE transactions on circuits and systems of video technology, volume 3, number 5, October 1993. This algorithm subdivides a frame into blocks of 8×8 pixels and tries to identify the position of this block in the next frame. The comparison of these locations makes it possible to assign a motion vector to each pixel block which comprises the ratio of the pixels replacement of the block and the time between two frames.

Michael Aron et al, “Handling uncertain sensor date in vision-based camera tracking”, proceedings of the third IEEE and ACM International Symposium on mixed and augmented reality, ISMAR 2004, describe a system for augmented reality (AR) which comprises a digital video camera and an inertial sensor fixed to this camera. The system is attached to the head of the AR user, whereby the sensor serves to detect rotations of the user's head. Camera positions are computed with key-points belonging to planar surfaces in AR schemes. If the inertial sensor detects a large camera rotation the vision-based tracking system uses the sensor data to adapt the search window for key-points in the next frame.

It is an object of the present invention to provide a method, a device and a corresponding computer program product for tracking objects or persons which can be used even when the tracked objects or persons experience large changes in their translational velocity.

This object and other objects are solved by the features of the independent claims. Preferred embodiments of the invention are described by the features of the dependent claims. It should be emphasized that any reference signs in the claims shall not be construed as limiting the scope of the invention.

According to a first aspect of the invention the above-mentioned object is solved by a method for tracking a movement of an object or of a person. A first step of this method consists of grabbing a sequence of digital video frames, whereby the video frames capture the object or person. In a second step values of a parameter are measured while grabbing the video frames, said parameter being indicative for the movement of the object or person. This means that the above-mentioned two steps are carried out simultaneously. The values of said parameter are measurement values which are obtained in a way described below in more detail. In a third step of the method the video frames are processed by means of a processing logic. The processing logic uses an algorithm which defines a pixel block in a frame and searches for this pixel block within a search area within a next frame. According to the invention the location of the search area within the next frame is dynamically adapted on the basis of the measurement values.

When carrying out the method as described above a device is used which comprises a digital video camera for grabbing said sequence of digital video frames, and which further comprises an input port for receiving values of said parameter. The parameter is indicative for the movement of the object or the person being captured by the video frames. In addition, the device comprises a processing logic for processing the video frames provided by the digital video camera. The processing logic is adapted to define a pixel block in a frame and to search for this pixel block within a search area in the next frame. The location of this search area within the next frame is dynamically adapted on the basis of the measurement values.

The above solution provides the advantage that an electronic processing of digital video frames with block matching algorithms is possible even in the case when the captured objects or persons experience large changes in their velocity. Block matching algorithms may use a search area for easing the computational burden. Without the dynamic adaptation of the search area a tracking of the object or person would fail or would be subject to a reduced performance. The reason is that in the case of large velocity changes the object might leave the search area in the next frame, a problem which is remedied by the dynamic adaptation.

A movement in the sense of the last paragraph is a translational movement. The translational movement might be a purely translational movement or might be a movement which comprises a translational velocity component. In both cases the tracked object might be located in a different part of the next frame after a change, in particular sudden change, of its translational velocity. In other words the invention fails to provide an advantage if the movement is a purely rotational movement.

According to a preferred embodiment of the invention adapting the location of the search area in the next frame is done by estimating or calculating the location of said pixel block in said next frame on the basis of the measurement values of said parameter. In other words the displacement of the pixel block is estimated or calculated on this basis. This means that external information, namely the measurement values of the parameter, is used for improving the output of the block matching algorithm.

This shall be explained in more detail for the case that the parameter is an acceleration vector. The acceleration vector is a quantity having a magnitude and a direction in three-dimensional space. This acceleration vector, which might be obtained by an acceleration sensor being external to or being part of the device for carrying out the invention, is mapped onto the plane in which the frame is located. Mathematically speaking this mapping is a projection of the three-dimensional acceleration vector onto a two-dimensional plane represented by the video frame. If the magnitude of the acceleration vector is denoted by a, the magnitude of the lateral displacement of a pixel block due to the acceleration vector is denoted by s, and the time is denoted by t, then s=0.5*a*t². S is expressed in units of pixels. The search area, which in a simple case might be a rectangle, will be shifted by an amount of s in the opposite direction when compared to the two-dimensional acceleration vector.

According to a preferred embodiment of the invention the search area is either adapted for each frame, or is adapted when the measurement value of the parameter is larger than a predefined threshold value. The first alternative is appropriate when the object or person experiences a series of velocity changes which would render it necessary to continuously adapt the search area from frame to frame. The second possibility is more appropriate in cases in which the object or person experiences a single velocity change only, e.g. because a vehicle has a collision with another vehicle. In the latter case the computational burden is reduced, which makes it easier to implement the device as a real-time system.

According to a preferred embodiment of the invention the algorithm for processing the video frames by the processing logic is a recursive search block matching algorithm, also being called a 3D-recursive search block matching algorithm. This algorithm works in the way as described by Gerard de Haan et al, “True motion estimation with 3D-recursive search block matching”, IEEE transactions on circuits and systems of video technology, volume 3, number 5, October 1993, to which this application explicitly refers to and which is incorporated by reference. This algorithm is extremely efficient even in comparison to other known block matching algorithms, such that the design of a device, which is operating in real-time becomes straightforward. In doing that there is a high degree of freedom as far as the choice of the processing logic is concerned, such that the execution of this recursive search block matching algorithm can be implemented in hardware as well as in software.

A processing logic may be
a) a processor and a corresponding computer program. As an example, the processor might be a TRIMEDIA processor or a XETAL processor of Philips, e.g. a Philips PNX1300 chip comprising a TM 1300 processor,
b) a dedicated chip, for example an ASIC or a FPGA,
c) an integral part of an existing chip of the video camera hardware, or
d) a combination of the possibilities mentioned above.

The preferred choice depends on system aspects and on product recruitments. A preferred embodiment of the processing logic uses an extra card to be inserted in digital video camera having a size of 180 mm×125 mm and comprising a Philips PMX1300 chip, which itself comprises a Philips TN1300 processor. Furthermore the card uses 1 MB of RAM for two frame memories and one vector memory.

According to a further preferred embodiment of the invention the movement of passengers within a vehicle is tracked. In this case the jerking heads of the passengers in the event of a collision can be tracked after the impact.

According to still another preferred embodiment the method can be used for optimizing the airbag inflation within a vehicle. Tracking the movement of the passengers in the case of a collision, and in particular tracking their heads, thus helps to optimize the exact time when an airbag should be triggered, and for designing an optimized shape of the airbag during the stages of its inflation. In this way damages to the passengers are kept to a minimum.

As can be derived from the above-mentioned explanations the method according to the invention, and in particular the processing of the video frames, can be carried out by means of a computer program. This computer program can be stored on a computer readable medium and serves to make the processing logic executable for receiving a sequence of video frames whereby the video frames capture an object or person. The computer program serves to receive values of a parameter while receiving the video frames, said parameters being indicative for the movement of the object or the person. Furthermore, the computer program serves to process the video frames with the sub-steps of

c1) using an algorithm which defines a pixel block in a frame and which searches for this pixel block within a search area of a next frame, and

c2) dynamically adapting the location of the search area within the next frame on the basis of the measurement values.

These and other aspects of the invention will be apparent from and elucidated with reference to the embodiments described thereafter. It should be noted that the use of reference signs shall not be construed as limiting the scope of the invention.

In the following preferred embodiments the invention will be described in greater detail by way of example only making reference to the drawings in which:

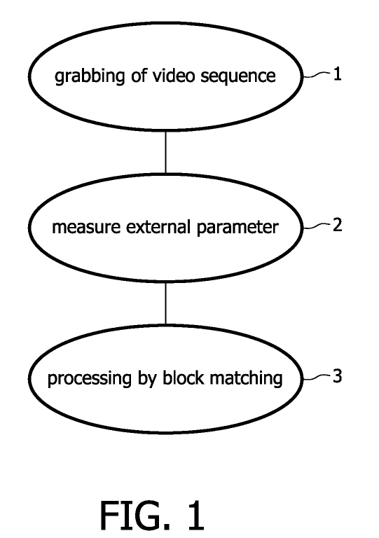

FIG. 1 shows a flowchart of the method according to the invention,

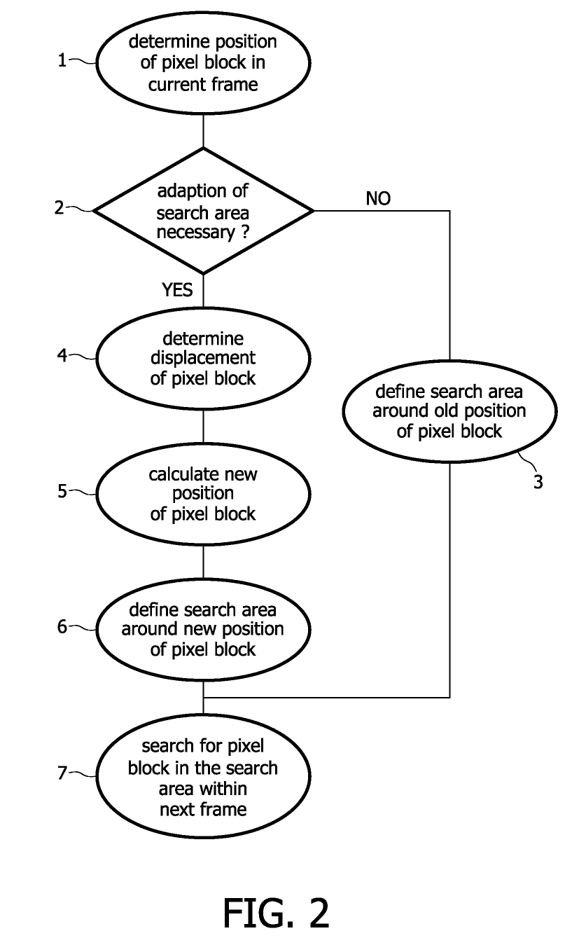

FIG. 2 shows a flowchart illustrating the block matching algorithm being central to the processing step of FIG. 1,

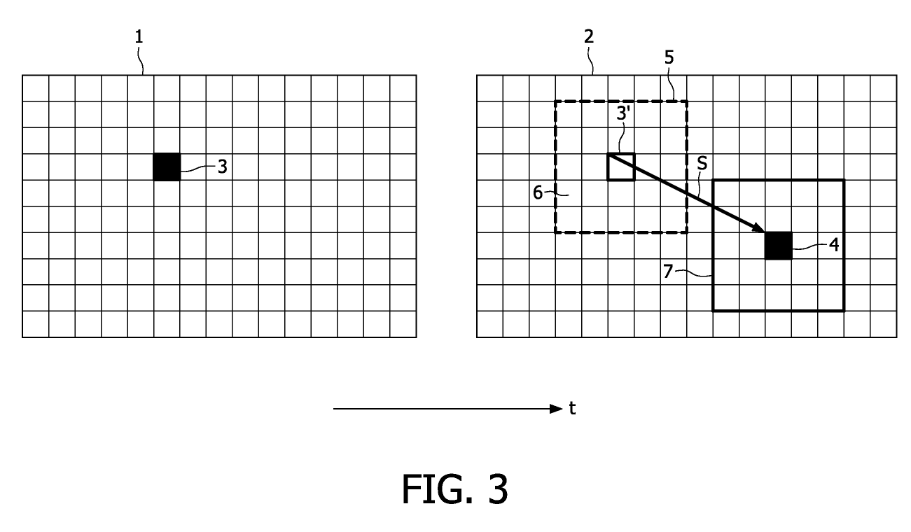

FIG. 3 illustrates the adaptation of the search area,

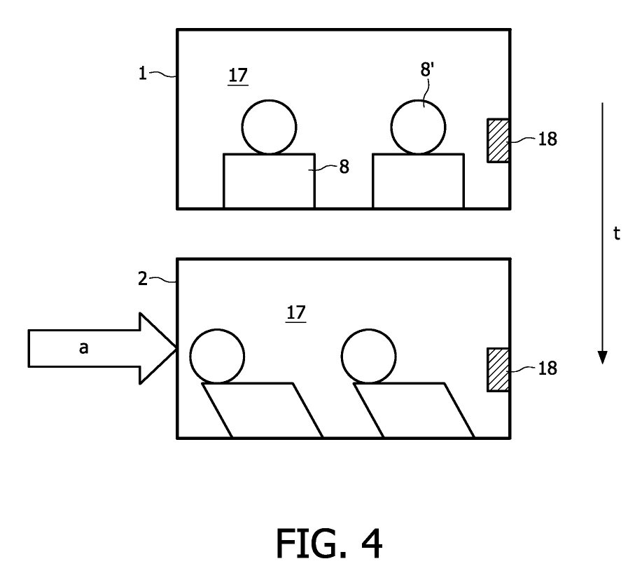

FIG. 4 shows in a schematic way a significant displacement of tracked persons due to an impact,

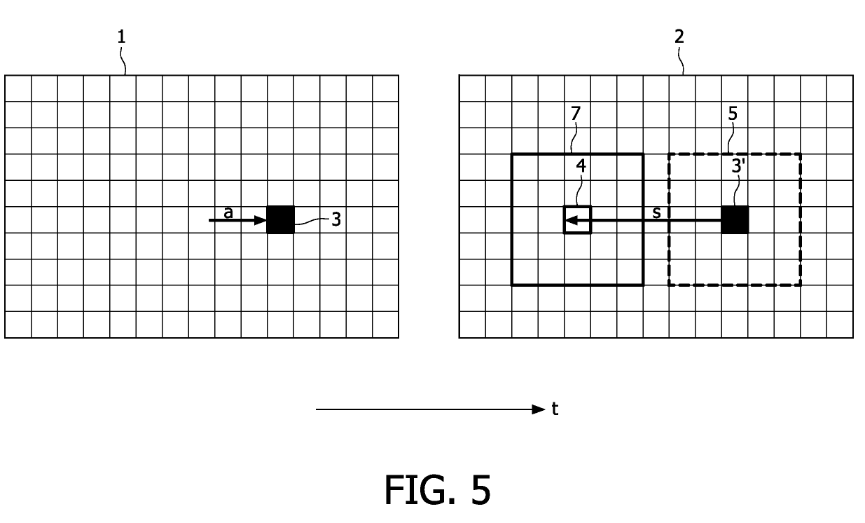

FIG. 5 shows the adaptation of the search area for the case of FIG. 4,

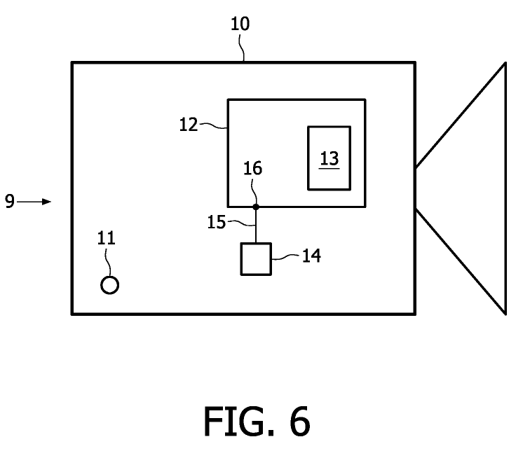

FIG. 6 shows a device according to the invention.

FIG. 1 is a flowchart illustrating the way in which the method according to the invention is carried out. In step 1 a grabbing of a sequence of digital video frames is carried out, whereby said video frames capture an object or a person. In step 2, which is carried simultaneously with step 1, an external parameter is measured. In step 3 the video frames obtained in step 1 are processed by a processing logic, whereby the processing logic uses a block matching algorithm, i.e. an algorithm which defines a pixel block in a frame and which searches for this pixel block within a search area within a next frame. Carrying out the block matching algorithm of step 3 is carried out with the help of a search area. The pixel block is only searched for in this search area of the next frame. The search area is dynamically adapted on the basis of the measured external parameters obtained in step 2.

FIG. 2 is a flowchart explaining in more detail the processing of the digital video frames of step 3 of FIG. 1. In step 1 of this flowchart the position of a pixel block in the current frame is determined which shall be compared with pixel blocks in the next frame in the same way as a conventional block matching algorithm. In step 2 the processing logic decides if the search area has to be adapted. This decision is based on the parameter measured beforehand. If this is not the case, e.g. because the velocity of the tracked object or person has not changed significantly, the method proceeds with step 3. In step 3 the search area is defined to be located around the old position of the pixel block and might be a rectangle around said pixel block. Then, the method proceeds with step 7. In step 7 a pixel block determined in step 1 is searched within the search area within a subsequent frame.

If the question in step 2 has been answered in the affirmative the method proceeds with step 4. In step 4 it is determined which displacement the pixel block of step 1 experiences due to an external influence such as an acceleration, e.g. due to collision. This acceleration is a vector quantity, and is the external parameter measured in step 2 of FIG. 1.

This displacement is calculated by determining the projection of the three-dimensional acceleration vector onto a plane spanned by the digital video frame. This mapping provides the direction of the acceleration, which is identical to the direction of the displacement and yields the magnitude of the displacement, which can be expressed in units of pixels.

Then the method proceeds with step 5 in which the new position of the pixel block is calculated with the direction and the magnitude of the displacement obtained in step 4.

Accordingly, a new search area as defined in step 6, whereby the new search area is located around the new position of the pixel block, whereby the new position is defined to be the old position of the pixel block being displaced due to the acceleration. The new search area is thus located around the new position of the pixel block, such that in step 7 the pixel block of step 1 is searched for in this new search area within the next frame.

FIG. 3 illustrates a way in which the location of the search area within the next frame is dynamically adapted. FIG. 3 shows two frames 1 and 2, whereby frame 1 is the current frame and whereby frame 2 is the next frame, i.e. the framed immediately following frame 1. This temporal behaviour is illustrated with the arrow indicating the development of time t for the frames 1 and 2. Frame 1 has a pixel block 3. If there would be no changes in the velocity of a tracked object which might be represented by said pixel block 3, the pixel block 3 would be searched for in the search area 5 of frame 2, as it could be expected that its position in frame 2 would remain constant. In this case the pixel block would be located at position 3′.

However, due to an external acceleration the location of pixel block 3 is shifted to position 4. Accordingly, this displacement s leads to a new search area 7 in which the pixel block 3 is searched for.

FIG. 4 shows two frames 1 and 2 with passengers 8 and 8′ in a vehicle 17. Frame 2 is a frame next to frame 1 as indicated by the arrow pointing downwards. Due to the acceleration a, confer the arrow pointing to the right, the passenger heads in frame 2 move to the left due to inertia. The jerking heads might be prevented from crashing against the interior of the vehicle by means of an airbag 18.

FIG. 5 shows the way in which the location of the search area in the next frame is dynamically adapted for the case of FIG. 4. In frame 1 the pixel block 3 is subjected to an acceleration a. Frame 2 is next to frame 1 in time t, confer the arrow pointing to the right. Due to the acceleration the position of pixel block shifts from position 3′ to position 4. Furthermore the acceleration leads to a displacement of the search area from a position 5 to a position 7.

FIG. 6 shows a device 9 for carrying out the method according to the invention. As far as the outer appearances is concerned this device is a digital video camera 10, which is modified in order to carry out the invention. The device 9 comprises said conventional digital video camera 10 as well as an input port 11 for receiving values of a parameter, e.g. an acceleration vector, said parameter being generally indicative for the movement of an object or person being captured by the video frames. The device further comprises a processing logic 12 for processing the video frames provided by the digital video camera 10. The processing logic 12 comprises a computer program 13. Furthermore, the device 9 has an acceleration sensor 14 outputting its data through a cable 15 and an input port 16 to the processing logic 12.

In operation, the processing logic 12 processes the video frames provided for by the digital video camera 10 and carries out a block matching algorithm, whereby the location of a search area is dynamically adapted within the next frame on the basis of the measurement values obtained either by the acceleration sensor 14 or by an external sensor which outputs its data and transmits them by means of input port 11 to the device 9.

### LIST OF REFERENCE NUMERALS

1 frame
2 next frame
3 old location of a pixel block
3′ old location of a pixel block
4 new location of a pixel block
5 search area
6 pixel block
7 new search area
8 passenger
8′ passenger
9 tracking device
10 digital video camera
11 input port
12 processing logic
13 computer program
14 sensor
15 cable
16 input port
17 vehicle
18 airbag
a acceleration
s displacement

1. Method for tracking a movement of an object or of a person, the method comprising the following steps:
a) grabbing a sequence of digital video frames (1, 2) and thereby capturing the object or person (8, 8′),
b) measuring values (measurement values) of a parameter while grabbing the video frames, said parameter being indicative for the movement of the object or person,
c) processing the video frames by means of a processing logic (12), whereby c1) the processing logic uses an algorithm which defines a pixel block (3) in a frame (1) and searches for this pixel block within a search area (7) within a next frame (2), and whereby c2) the location of the search area within the next frame is dynamically adapted on the basis of the measurement values.

2. Method according to claim 1, characterized in that for adapting the location of the search area the location of the pixel block (4) in the next frame is calculated or estimated on the basis of the measurement values.

3. Method according to claim 1, characterized in that the parameter is an acceleration vector or is a velocity vector.

4. Method according to claim 1, characterized in that the search area is either adapted for each frame, or is adapted when the measurement value is larger than a predefined threshold value.

5. Method according to claim 1, characterized in that the algorithm is a recursive search block matching algorithm.

6. Method according to claim 1, characterized in that the processing logic is implemented in hardware or is a computer program (13).

7. Method according to claim 1, characterized in that the movement of passengers (8, 8′) within a vehicle (17) is tracked.

8. Method according to claim 1, characterized in using it for optimizing an airbag (18) inflation within a vehicle.

9. Computer program product, the computer program product comprising a computer readable medium, having thereon computer program code means, when said program is loaded, to make the computer executable for executing the following steps:
a) receiving a sequence of digital video frames (1, 2), the video frames capturing an object or a person (8, 8′),
b) receiving values of a parameter while receiving the video frames, said parameter being indicative for the movement of the object or person,
c) processing the video frames, said processing including the sub-steps of
c1) using an algorithm which defines a pixel block (3) in a frame (1) and which searches for this pixel block within a search area (7) of a next frame (2), and whereby
c2) the location of the search area within the next frame is dynamically adapted on the basis of the measurement values.

10. Computer program product according to claim 9, characterized in that for adapting the location of the search area the location of the pixel block in the next frame is estimated on the basis of the measurement values.

11. Computer program product according to claim 9, characterized in that the search area is either adapted for each frame, or is adapted when the measurement value is larger than a predefined threshold value.

12. Device for tracking the movement of an object or of a person from a sequence of video frames, comprising:
a) a digital video camera (10) for grabbing a sequence of video frames (1, 2),
b) an input port (11, 16) for receiving values of a parameter while, said parameter being indicative for the movement of a object or a person (8, 8′) being captured by the video frames,
c) a processing logic (12) for processing the video frames provided by the video camera, said processing logic being adapted to c1) define a pixel block (3) in a frame (1) and to search for this pixel block within a search area (7) of a next frame (2), and c2) to dynamically adapt the location of the search area within the next frame on the basis of the measurement values.

13. Device according to claim 12, characterized in that the device further includes a sensor (14) for providing the measurement values.

14. Device according to claim 13, characterized in that the sensor is an acceleration sensor.
